(19) United States
(12) Patent Application Publication
(10) Pub. No.: US 2010/0003913 A1
(43) Pub. Date: Jan. 7, 2010

(54) HVAC AIR DUCT VENT COVER AND METHDOLOGY FOR ITS USE

(76) Inventor: John Patrick Sanchez, Reno, NV (US)

Correspondence Address: LONG & CHYBIK, 1575 DELUCCHI LANE, SUITE 32, RENO, NV, 89502, US

(21) Appl. No.: 12/495,753

(22) Filed: Jun. 30, 2009

Related U.S. Application Data
(60) Provisional application No. 61/077,126, filed on Jun. 30, 2008.

(51) Int. Cl. F24F 13/20; B23P 19/04

(52) U.S. Cl. 454/275; 29/700

(57) ABSTRACT

One possible embodiment of the present invention could be a cover for sealing a ceiling-mounted HVAC vent comprising of a rectangular base with several edges; several rectangular cover walls, each cover wall being attached to a respective edge, the base and cover walls being originally arranged in a cruciform shape; wherein the cover walls provide a force fit upon the interior sides of a framework of a ceiling mounted HVAC vent to hold the cover in place within the hollow interior of the framework.

### CROSS-REFERENCES TO RELATED APPLICATIONS

This application claims the benefit under 35 U.S.C. § 119(e) of U.S. Provisional Patent Application No. 61077126 filed on Jun. 30, 2008, the contents of which are relied upon and incorporated by reference.

### STATEMENT REGARDING FEDERALLY SPONSORED RESEARCH OR DEVELOPMENT

Not Applicable

### REFERENCE TO A “MICROFICHE APPENDIX”

Not Applicable.

1. Field of the Invention

The present invention generally relates to covers for HVAC air duct vents that may be generally located in the ceilings of building.

2. Background

A building (e.g., residential, commercial, office, industrial, or the like structure) may have an environmental control means, such as a forced air heating, ventilating, and air conditioning system (hereinafter “HVAC”), which generally maintains a desired internal environment by distributing treated forced air to various areas of the building's interior. This distribution could include the intake of air by HVAC air intake vents with subsequent transportation by HVAC intake ductwork to a heating and air conditioning unit. The unit then can then treat the air (e.g., heat or cool the air) and force the treated air through HVAC outtake ductwork to air outlet vents located in the walls, ceilings, floors, and the like of the structure. The treated forced air then passes through the HVAC air outlet vents to generally enter the interior environment of the building.

During the construction of the building, the ceiling-mounted intake and outlet vents may be susceptible to construction dust and debris contamination. Once HVAC subcontractors have generally finished installing the HVAC ductwork with ceiling-mounted outlet and intake vents, then non-HVAC subcontractors generally come in and install the ceiling itself (e.g., put in dry wall; apply texture and paint; and the like.) In doing so, the non-HVAC subcontractors may overspray or otherwise apply to portions of the ceiling-mounted vents as well as to the interiors of HVAC ductwork proximate to such vents, various ceiling construction materials such as texture, paint, drywall mudding compound, and other such products.

Because the interior of the HVAC ductwork may have a polymer liner with a low stick surface and the ceiling mounted vents may be constructed of metal with an oiled surface, such an excess application of ceiling construction products (if not properly removed after the wall construction is completed) may be easily dislodged from the ductwork and ceiling mounted vents through the operation of the HVAC system (e.g. through airflow movement over the excess ceiling materials and the like.) Such dislodged applied ceiling products (from air intake vents and proximate HVAC ductwork) may be taken further into the HVAC system. These ceiling product materials (as well as other contaminants such as construction debris, dust, and the like) may reach the HVAC air condition and heating unit, where they and other contaminants could be particularize into a very fine dust that is subsequently issued out by the HVAC system and distributed (repeatedly) throughout the building's interior.

Similar distribution could occur for any excess ceiling material left on the air outlet vents and proximate downstream HVAC ductwork. Here excess material could flake off from the surfaces of such portions of the HVAC system to be blown out of the system and out into the interior environment of the building.

Such a distribution of fine dust and other contaminants from the Building's HVAC system to the interior environment after the completion of the building construction could be much to aggravation of the building's occupants. The removal of this widespread contamination from both the HVAC system and the building's interior could further require significant money, time, and resources.

What is needed therefore is a cover that can be generally employed over the ceiling-mounted HVAC intake and outlet vents during construction to reduce the incident of ceil product and construction debris contamination of the vents; remaining portions of the HVAC system; and building's interior.

SUMMARY OF ONE EMBODIMENT OF THE INVENTION

### Advantages of One or More Embodiments of the Present Invention

The various embodiments of the present invention may, but do not necessarily, achieve one or more of the following advantages:

provide an easy-to-construct and install cover for ceiling-mounted HVAC vents to reduce the amount of ceiling material that is applied to interiors of such vent and associated HVAC ductwork connected to such vents;

an ability to limit the amount of excess ceiling products and construction particulate matter that can enter into an HVAC system;

provide a means to reduce the amount of effort and resources needed to clean up a building's interior environment after construction is generally completed;

an ability to limit the amount of excess ceiling products and construction particulate matter that can be distributed by an HVAC system to a building's interior environment;

an ability to limit the amount of dust that could be created and distributed by the HVAC system; and

provide a means to reduce of amount of excess ceiling material and construction dust that can be distributed by an HVAC system throughout the interior of a building.

These and other advantages may be realized by reference to the remaining portions of the specification and abstract.

### BRIEF DESCRIPTION OF ONE EMBODIMENT OF THE PRESENT INVENTION

One possible embodiment for the invention could be a cover for sealing a ceiling-mounted HVAC vent comprising of a base with several edges; several rectangular cover walls, each cover wall being attached to a respective edge, wherein the cover walls provide a force fit upon the interior sides of a framework of a ceiling mounted HVAC vent to hold the cover in place within the hollow interior of the framework.

One other possible embodiment for the invention could be a methodology of using a cover to reversibly seal a ceiling-mounted HVAC vent comprising of providing a ceiling-mounted HVAC vent, the vent having an open multi-sided framework with each wall of the framework having a respective interior side and exterior side, the interior sides forming a hollow interior, wherein the framework is continuously connected to ceiling-located ductwork of a HVAC system of a building; providing a cover having a rectangular base from which multiple rectangular cover walls originally spread outward from the base in the same plane as the base; placing the cover into the hollow interior of the framework so each of the cover walls come into contact with a respective interior side; and holding the cover in place within the hollow interior through friction fit between the cover wall and its respective interior side to seal off the vent.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a perspective cutaway view of an embodiment of ceiling mounted HVAC outlet and intake air vents.

FIG. 2 is substantially a perspective cutaway view of one embodiment of the present invention.

FIG. 3 is substantially a perspective cutaway view of one embodiment of the present invention being fitted to a HVAC vent.

FIG. 4 is substantially a perspective cutaway of yet another embodiment of the present invention being placed in a HVAC vent.

FIG. 5 is substantially a perspective cutaway of yet another embodiment of the present invention being taped to a HVAC vent.

FIG. 6 is substantially flow chart of one possible process for using the cover.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

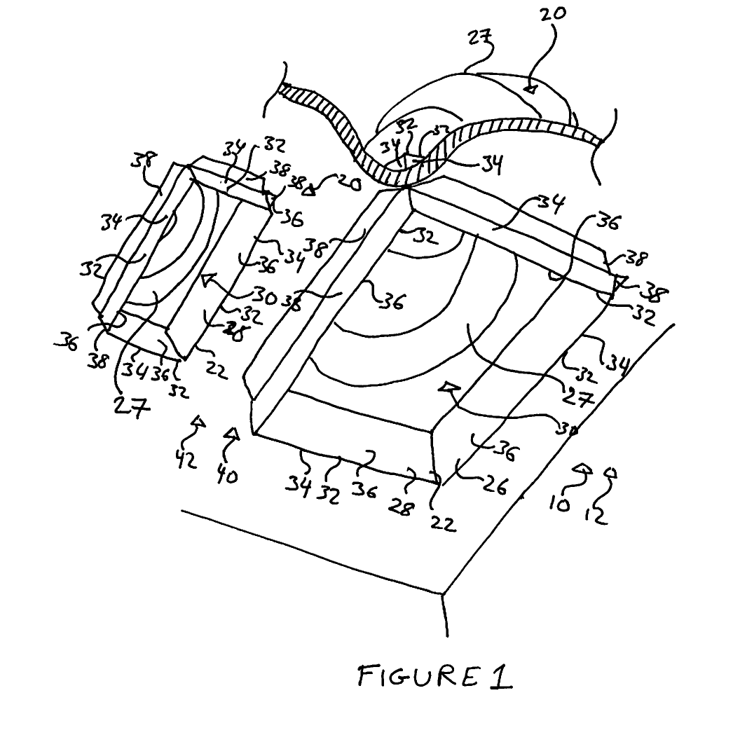

As substantially shown in FIG. 1, a room 10 in a building under construction 12 could have HVAC system 20 having ceiling-mounted vents 22 (e.g., outlets 24 and intakes 26) connected to open ended HVAC ductwork 27 to provide for the passage of air into and out of the HVAC system 20. These vents 22 could have a metal, box-shaped framework 28 forming a generally hollow, pass-through interior 30. The framework 28 could further feature four walls 32, with each wall 32 having an exterior side 34 and an interior side 36. The frame work could connect to open end of a HVAC duct. In at least one embodiment, the exterior side 34 could also feature a support flange 38, oriented perpendicular to its respective wall 32, allowing the support flange 28 to lay upon the drywall portion 40 of the ceiling 42 to further support the vent upon the ceiling 42.

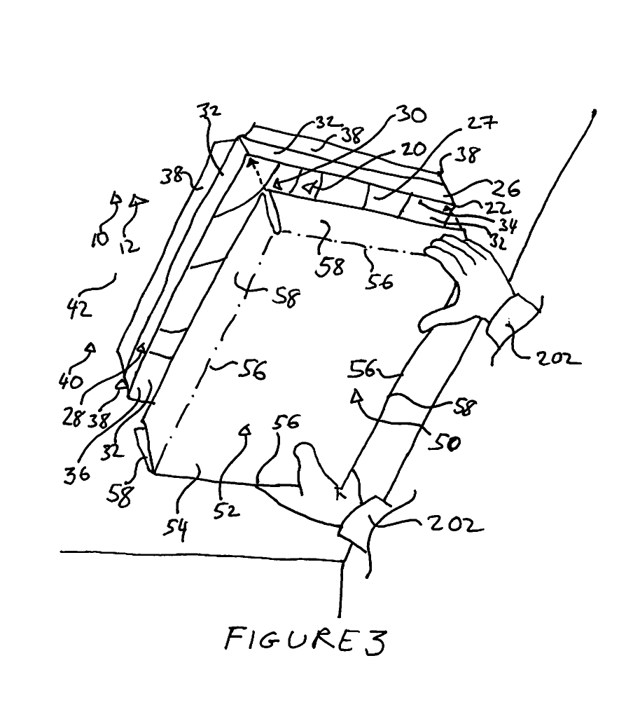

As substantially shown in FIG. 2, the invention 50 could be a HVAC air duct vent cover 52 for reversibly and easily sealing off ceiling-mounted HVAC vents 22 from air contaminants and the like from the room to which the air duct connects the HVAC system and a methodology or process 200 of using same. The invention 50 could comprise of a base 54 having multiple edges 56, a cover wall 58 descending from a respective edge 56, each cover wall 58 generally being placed into a perpendicular orientation to the base 50.

On possible manner of construction for the cover 52 could have the cover 52 be made from cardboard or other suitable resilient material could have a body comprising of a rectangular-shaped base 54 with multiple edges 56 and several outspread rectangular-shaped cover walls 58 attached to respective edges 56. The cover walls 58 as generally connected to the base 54 to substantially provide the cover 52 with an initial cruciform shape. The cover walls 58 could further be bent out of the original planar relations with the base 54 to place the cover walls 58 in a generally perpendicular orientation to the base 54 wherein the cover walls 58 are all on the same side of the base 54. The cover walls 58 could be further flexibly connected to the base 54 so they could be moved to various positions to accommodate the placement of the cover 52 within the hollow interior 30 of the vent 22. The construction of the cover 52 with resilient material could allow the cover walls 58 to be biased outward away from the base 54 (correspondingly biased towards the interior sides 36 of the walls 32 of the vent framework 28) so that when they came into contact with the interior sides 36, the cover walls 58 could exert a force upon the interior sides 36 to create force fit to hold the cover 52 within hollow interior 30 of the framework 28.

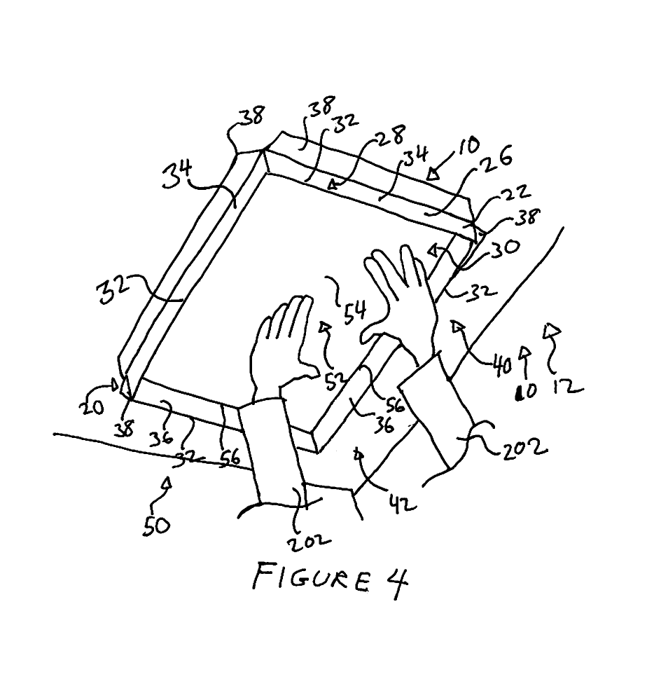

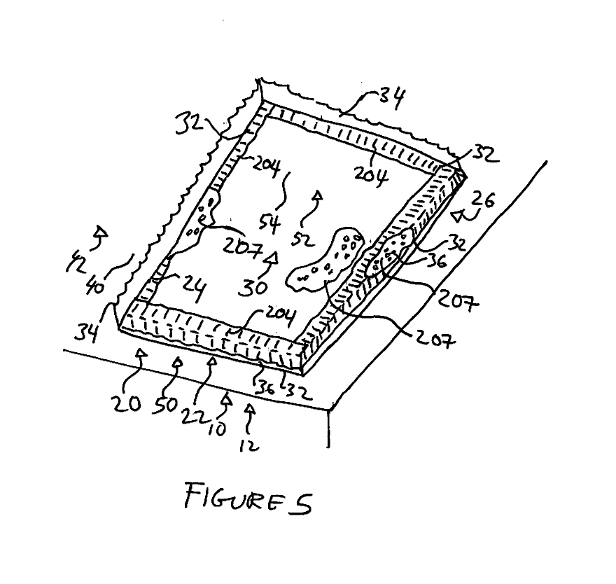

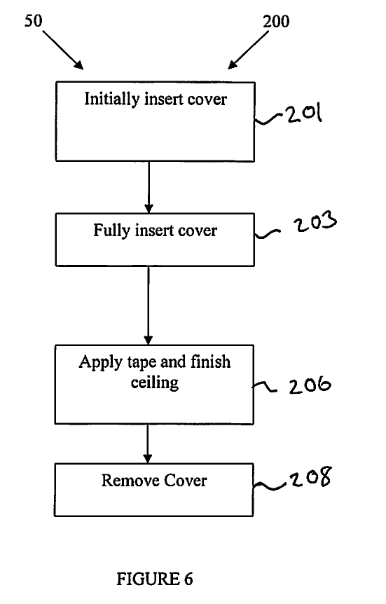

In operation, as substantially shown in FIGS. 3-6, the process 200 could start with step 201, where in the operator (e.g., HVAC subcontractor) 202 grasps and moves the cover 52 towards the ceiling-mounted HVAC vent 22 to be covered so that the cover walls 58 are generally enter the hollow interior 30. The operator at step 202 may then further maneuver the cover 52 into the vent 22 so that the base 54 is placed within the hollow interior 30 with the cover walls 58 generally making significant contact with the interior sides 36 of the vent framework 28. In this manner, the base 54 and cover walls 58 make substantial contact with the framework 28 of the vent 22 to generally form a friction fit that holds the cover 52 in place in the vent 22. The operator in step 203 then can further reversibly apply tape 204 to any portion of the interior wall 36 still exposed to the building's interior environment.

The non-HVAC subcontractors (not shown) in step 205 with the cover 52 in place in the vent 22, can come in and complete the ceiling 42 that abuts the vent (e.g., put in dry board; apply mudding, texture and paint; and the like.) Any excess ceiling material that normally would have found its way on to the interior sides of the vent 22 is keep out by (e.g., applied to) the cover (and any tape applied in conjunction with the cover.)

Once the ceiling installation is completed, then in step 207, the operator 202 can remove the tape 204 and cover 52 (not shown). Any excess ceiling material applied to the tape 204 and cover 52 is also removed in the same manner. The operator 202 can then finish applying vent screens (not shown) and the like to the vent(s) 22 as needed or otherwise required.

Using this process 200, the actions of completing the ceiling does not result in excess ceiling material being applied to the interior portion of the ceiling-mounted vent(s) and the interior of the associated HVAC ductwork 27. This reduces the likelihood of introduction of construction containments and excess ceiling material into the HVAC system 20 that otherwise could result in a fine dust that could be subsequently spread by the HVAC system throughout the building's interior.

### CONCLUSION

As the above description shows, the invention is a cover for HVAC duct vent and a methodology for its respective use. The invention can be deployed to limit the amount of ceiling material and construction dust that could be applied to the interior portion of ceiling mounted HVAC vent and ductwork during building construction. The invention may further prevent entry of such material into the HVAC system which may cause the HVAC system to create and spread a very fine dust into the interior of the building which could result in significant cost to provide the necessary resources to clean out the HVAC system and building interior.

Although the description above contains many specifications, these should not be construed as limiting the scope of the invention but as merely providing illustrations of some of the presently preferred embodiments of this invention.

What is claimed is:

1. A cover for sealing a ceiling-mounted HVAC vent comprising of:
(A) a rectangular base with several edges;
(B) several rectangular cover walls, each cover wall being attached to a respective edge, the base and cover walls being originally arranged in a cruciform shape;
wherein the cover walls provide a force fit upon the interior sides of a framework of a ceiling mounted HVAC vent to hold the cover in place within the hollow interior of the framework.

2. The cover of claim 1 wherein cover is made of a resilient material.

3. The cover of claim 1 wherein the cover walls are further be bent out of the original planar relations with the base.

4. The cover of claim 3 wherein the cover walls once bent out of the original planar relations with the base are all on the same side of the base.

5. The cover of claim 3 wherein the cover walls 58 are biased outwards from the base.

6. The cover of claim 3 wherein the cover walls are biased towards the interior sides of the respective walls of the framework of the vent.

7. The apparatus of claim 3 wherein the bias of the cover walls towards the interior side of the framework provides the force fit holding the cover within the framework.

8. A methodology of using a cover to reversibly seal a ceiling-mounted HVAC vent comprising of the following steps, but not necessarily in the order shown:
(A) providing a ceiling-mounted HVAC vent, the vent having an open multi-sided framework with each wall of the framework having a respective interior side and exterior side, the interior sides forming a hollow interior, wherein the framework is continuously connected to ceiling-located ductwork of a HVAC system of a building;
(B) providing a cover having a rectangular base from which multiple rectangular cover walls originally spread outward from the base in the same plane as the base;
(C) placing the cover into the hollow interior of the framework so each of the cover walls come into contact with a respective interior side; and
(D) holding the cover in place within the hollow interior through friction fit between the cover wall and its respective interior side to seal off the vent.

9. The process of claim 8 further comprising of a step of moving the cover walls out of planar relationship with the base.

10. The process of claim 9 further comprising of a step of bending the cover walls along the respective edges of the base.

11. The process of claim 9 further the step of moving the cover walls causes all the cover walls to be on the same side of the base.

12. The process of claim 9 wherein the moving of cover walls allows the cover to fit within the hollow interior of the framework of the vent.

13. The process of claim 9 further comprising of a step of biasing the cover walls away from the base.

14. The process of claim 9 further comprising of a step of biasing the cover walls towards the interior sides of the walls of the framework of the vent.

15. The process of claim 14 wherein the biasing of the cover walls towards the interior sides provides the friction fit.

16. The process of claim 8 further comprising of a step of inserting the cover walls into the vent prior to the insertion of the base within the vent.

17. The process of claim 8 further comprising of a step of applying tape to the portions of the base and to portions interior sides to further seal off the vent.

18. The process of claim 8 further comprising of a step of blocking the application of excess ceiling material into the hollow interior of the vent.
